(19) United States
(12) Patent Application Publication
(10) Pub. No.: US 2016/0201495 A1
(43) Pub. Date: Jul. 14, 2016

(54) GAS TURBINE AND MOUNTING METHOD

(71) Applicant: SIEMS AKTIENGESELLSCHAFT, München (DE)

(72) Inventors: Fathi Ahmad, Kaarst (DE); Michael Händler, Erkrath (DE); Kevin Kampka, Mulheim a. d. Ruhr (DE); Christian Kowalski, Oberhausen (DE); Christian Kowalzik, Berlin (DE); Nihal Kurt, Dusseldorf (DE); Stefan Schmitt, Mulheim an der Ruhr (DE); Peter Schröder, Essen (DE)

(73) Assignee: Siemens Aktiengesellschaft, Munich (DE)

(21) Appl. No.: 14/910,025

(22) PCT Filed: Aug. 5, 2014
(86) PCT No.: PCT/EP2014/066842

§ 371 Date: Feb. 4, 2016

(30) Foreign Application Priority Data
Aug. 9, 2013 (EP) 13179889.4

(51) Int. Cl. F01D 11/08; F02C 3/04; F01D 25/28

(52) U.S. Cl. CPC F01D 11/08; F01D 25/28; F02C 3/04; F05D 2220/32

(57) ABSTRACT

A gas turbine includes a turbine having a rotor blade row and a ring that is arranged around the rotor blade row and is made up of multiple ring segments. An insert element covers a recess of a ring segment body of the turbine. The ring segment body has a recess on a hot-gas side. The insert element has a concavely shaped front face and a rear face with a rear face profile, and the rear face profile corresponds to a negative shape of a profile of the recess. A mounting method includes an insert element fixed to a recess of a ring segment body of a turbine of a gas turbine.

### CROSS REFERENCE TO RELATED APPLICATIONS

This application is the US National Stage of International Application No. PCT/EP2014/066842 filed Aug. 5, 2014, and claims the benefit thereof. The International Application claims the benefit of European Application No. EP13179889 filed Aug. 9, 2013. All of the applications are incorporated by reference herein in their entirety.

### FIELD OF INVENTION

The present invention relates to a gas turbine and to a mounting method.

### BACKGROUND OF INVENTION

It is known and widespread that rotor blade rows of turbines of gas turbines have, at the upper end of the blade airfoils, what is termed a shroud.

US 2004/047725 A1 shows a ring segment of an annular form which is arranged around the outer circumference of rotor blades of a gas turbine. The ring segment comprises a blade ring, a main shaft and rotor blades with multiple individual units which define an annular form in that they are arranged around the circumferential direction of the main shaft and are arranged such that their inner peripheral surface is guided at a constant distance from the tips of the rotor blades. In that context, the individual units form depressions, which extend along the axial direction of the main shaft of the turbine, such that they are opposite one another. The ring segment also comprises a sealing plate, which is fitted in each opposing pair of the depressions such that the adjoining pairs of the individual units are connected to one another, and contact surfaces, which are formed at positions radially further inward than the sealing plates and extend in the axial direction and the circumferential direction and are in contact with one another.

US 2011/044805 A1 discloses a cooling system for a ring segment of a gas turbine. The cooling system comprises an impingement plate which has multiple small holes, a cooling space which is enclosed by the impingement plate and a main body of a segment body, a first cavity which is arranged in a downstream end position of the segment body in the flow direction of the combustion gas, such that it stands perpendicular to an axial direction of a rotation shaft, a first cooling duct which is connected to the cooling space and the first cavity, and a second cooling duct which is connected to the first cavity and a combustion chamber, which is arranged in a downstream end position of the segment body in the flow direction of the combustion gas.

A cooled turbine ring segment for a gas turbine is known from US 2004/120803 A1, which segment comprises an axially oriented shroud ring segment having an inner surface, an outer surface, an upstream flange and a downstream flange. The flanges hold the shroud ring in an engine casing. A perforated cooling air impingement plate is arranged on the outer surface of the shroud ring, between the upstream flange and the downstream flange, with an impingement chamber defined between the impingement plate and the outer surface. Axial cooling bores in the ring segment extend between the impingement chamber and an outlet. A hollow adjoining the outlet guides cooling air from the outlet in the direction of a downstream guide vane, in order to cool the guide vane.

The shroud makes it necessary, during work on the rotor blade row which for example takes place for maintenance or testing purposes, to perform what is referred to as a cover lift, that is to say lifting the entire upper casing part. A cover lift is very onerous.

### SUMMARY OF INVENTION

The present invention is based on an object of resolving these drawbacks and of providing an insert element, a ring segment, a gas turbine and a mounting method, such that it is also possible to operate a rotor blade row without a shroud in the gas turbine.

This object is achieved a gas turbine as claimed and a mounting method as claimed. Advantageous refinements of the invention are specified in the subclaims and described in the description.

According to the invention, it is provided, in the case of a gas turbine having multiple rotor blade rows, that, in the case of that rotor blade row being the one situated downstream of the other rotor blade rows, there is provided around it a ring consisting of multiple ring segments, of which at least one comprises a ring segment body and an insert element, wherein the insert element for covering a recess of a ring segment body of a turbine of a gas turbine has a concave front side and a rear side with a rear side profile. The rear side profile corresponds to a negative shape of a recess profile of a recess. In that context, the recess is arranged on a hot gas side of the ring segment body. By virtue of the recess, the ring segment body is designed for operation with a rotor blade row having a shroud.

In that context, it is further provided that, in the mounted state of the ring segment body in the turbine, the insert element can be introduced into the hot gas path and can then be fixed to the ring segment body.

This arrangement advantageously makes it possible to convert a gas turbine from operation with a rotor blade row having a shroud to operation with a rotor blade row without a shroud, without this requiring the use of new ring segments. This dispenses with the need for an onerous cover lift. It is also possible to save on onerous new manufacture of matching ring segments.

Thus, there is advantageously provided a gas turbine which is suitable for operation with a rotor blade row without a shroud. When replacing the rotor blades, it is not necessary to lift off the upper casing of the gas turbine (cover lift). Access from the outlet side is sufficient. The gas turbine according to the invention is thus particularly suitable for testing purposes, which involve more frequent changes to the blade airfoils. The present invention allows these tests to be set up and carried out substantially more quickly.

In addition, the gas turbine according to the invention can easily be converted for operation with a rotor blade row having a shroud, by removing the at least one insert element from the ring segment body.

By virtue of the fact that the rear side profile essentially corresponds to the negative shape of the recess profile, the insert element can be quickly, easily and precisely positioned on the ring segment body before it is secured. Mounting of the insert element can thus be carried out more simply and more easily.

In one advantageous embodiment of the insert element according to the invention, the insert element has at least one passage running from the front side to the rear side.

Thus, the insert element can be attached to the ring segment body simply using at least one corresponding attachment means such as a screw or a bolt.

In a further advantageous embodiment of the insert element according to the invention, the insert element has, on the front side, at least one depression arranged coaxially with the passage.

The attachment means for attaching the insert element, in particular the head of a screw, can be arranged in the depression so as not to stand proud of the contour of the insert element.

In a further advantageous embodiment of the insert element according to the invention, the passage has a convexity. In contrast to the depression, the convexity is not arranged on the front side of the insert element but rather inside the insert element. The cross section area of the passage is thereby smaller at the front side and at the rear side than in the region of the convexity.

Bolts or screws for mounting the insert element can be introduced from the side. Their heads do not stand proud of the contour of the insert element. In the direction of the front side, it is possible to produce a form fit between bolt and insert element, which prevents the bolt from sliding out, in particular during overhead mounting. This simplifies the mounting of the insert element on the ring segment body.

In a further advantageous embodiment of the insert element according to the invention, in the passage there is arranged a bolt which has a head protruding into the convexity.

The bolt is thus arranged in a form-fitting manner in the insert element. When mounting the insert element on the ring segment body, it is not necessary to additionally introduce and position the bolt. This further simplifies mounting.

The ring segment, according to the invention, of a turbine of a gas turbine comprises a ring segment body having a hot gas side which, in the mounted state, is oriented toward a hot gas path. The ring segment body has, on the hot gas side, a recess. In the recess there is arranged an insert element of the type described above.

The ring segment is thus designed for operation of a rotor blade row without a shroud.

The insert element according to the invention is advantageously integrated into a gas turbine.

In the mounting method according to the invention, an insert element is fixed to a recess of a ring segment body of a turbine of a gas turbine. In that context, the recess is arranged on a hot gas side which, in the mounted state of the ring segment body, is oriented toward a hot gas path of the gas turbine. In particular, in the mounted state of the ring segment body, the insert element is introduced into the hot gas path and is then fixed to the ring segment body.

It is thus possible, in particular for test purposes, for a ring segment of a gas turbine to be readily converted from a configuration for operation with a rotor blade row having a shroud to a configuration for operation with a rotor blade row without a shroud. A reverse change is also easily possible.

### BRIEF DESCRIPTION OF THE DRAWINGS

Exemplary embodiments of the invention will be discussed in more detail on the basis of the drawings and the following description. In the drawings:

FIG. 1 shows a gas turbine according to the invention,

FIG. 2 shows a ring segment according to the invention,

FIG. 3 shows an insert element according to the invention, and

FIG. 4 shows the insert element according to the invention in a further embodiment.

### DETAILED DESCRIPTION OF INVENTION

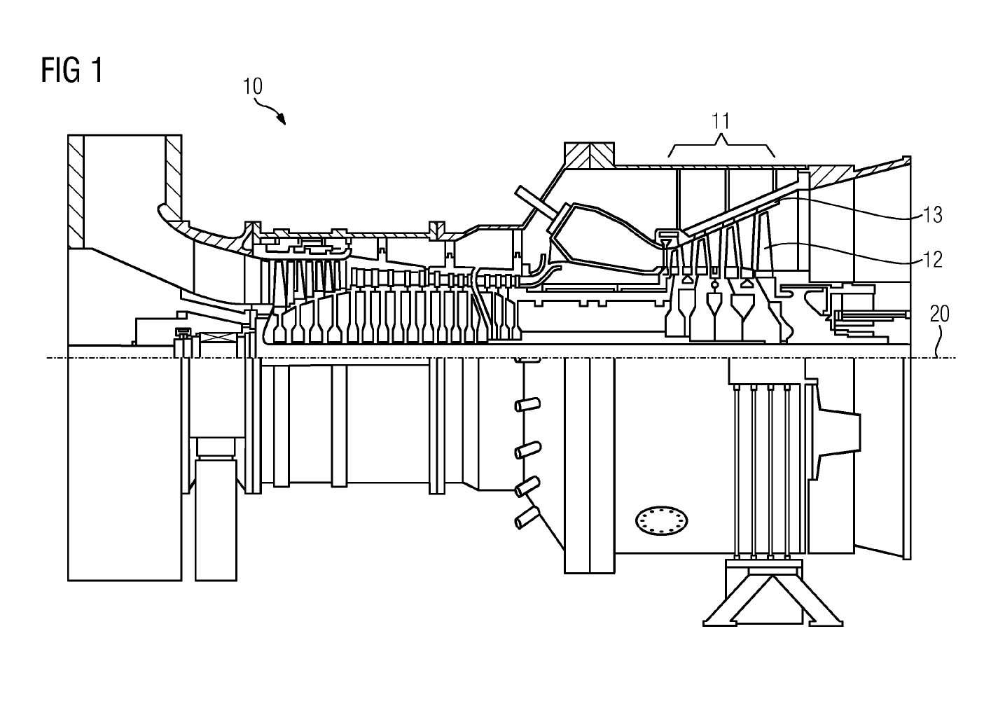

FIG. 1 shows a gas turbine 10 according to the invention, in an exemplary embodiment. The gas turbine 10 comprises a turbine 11 in which there is arranged at least one rotor blade row 12. Around this rotor blade row 12, there is arranged a ring consisting of multiple ring segments. The rotor blade row 12 is arranged so as to be able to rotate about an axis of rotation 20.

The rotor blade row 12 is in particular the one situated downstream of the other rotor blade rows. In FIG. 1, the corresponding rotor blade row 12 is the fourth rotor blade row of the turbine 11 of the gas turbine 10.

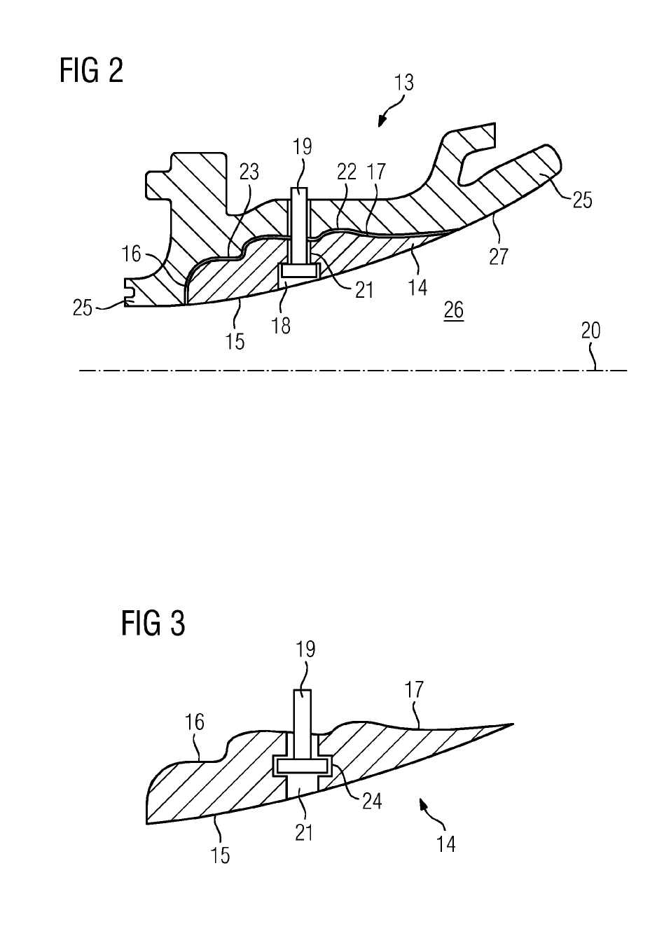

The gas turbine 10 according to the invention has at least one ring segment 13 according to the invention. FIG. 2 shows a section view of the ring segment 13, in an exemplary embodiment.

The ring segment 13 comprises a ring segment body 24 and an insert element 14 according to the invention.

The ring segment body 25 comprises a hot gas side 27. In the mounted state, the hot gas side 27 is oriented toward a hot gas path 26 of the gas turbine 10.

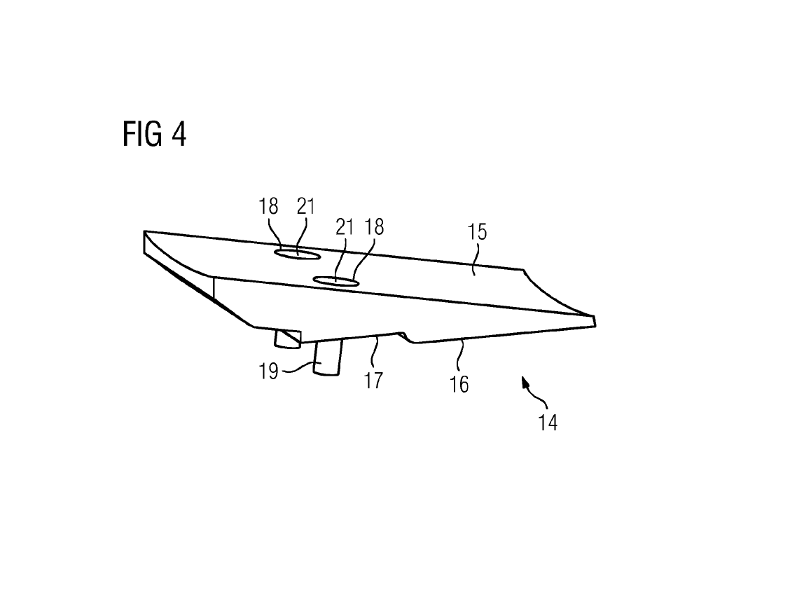

The insert element 14 is shown in FIG. 2 in a first exemplary embodiment and in FIG. 3 in a further exemplary embodiment in a section view. FIG. 4 shows the insert element 14 in isolation.

The insert element 14 according to the invention is designed to cover a recess 23 in the ring segment body 25. The ring segment body 25 has this recess 23 for operation of the gas turbine 10 with a rotor blade row which has a shroud. In order for it not to be necessary to remove the entire upper casing half of the gas turbine (cover lift), for example during a testing phase, it is advantageous to use the rotor blade row 12 without a shroud. The insert element 14 according to the invention makes it possible for the ring segment body 25 to be adapted to the rotor blade row 12 which has no shroud.

The adaptation takes place by means of a mounting method according to the invention, in which the insert element 14 is fixed to the recess 23. In particular, this can take place while the ring segment body 25 is already mounted in the gas turbine 10. To that end, the insert element 14 is introduced into the hot gas path 26 and is then fixed to the ring segment body 25.

The insert element 14 has a rear side 16 and a concave front side 15. In the mounted state, the front side 15 is oriented toward the hot gas path 26. The rear side 16 has a rear side profile 17. This rear side profile 17 essentially corresponds to the negative shape of a recess profile 22 of the recess 23. In the embodiment shown in FIG. 2, the insert element 14 almost entirely fills the recess. In particular, the insert element 14 is configured such that it touches the ring segment body 25 at at least three points. This permits quick and reliable positioning during mounting.

The insert element 14 advantageously has at least one passage 21 running from the front side 15 to the rear side 16. The passage 21 serves for attaching the insert element 14 to the ring segment body 25. In that context, means for attaching the insert element 14 are fed through the passage 21. FIGS. 3 and 4 show bolts 19 as attachment means. The bolts 19 are in particular threaded bolts or screws. In the mounted state, the insert element 14 is securely connected to the ring segment body 25. In the mounted state, the insert element 14 is advantageously flush with the ring segment body 25.

The front side 15 of the insert element 14 is concave and thus adapted to the ring segments 13 arranged around the rotor blade row 12. In the mounted state, the concave curvature of the front side 15 is perpendicular to the axis of rotation 20.

The insert element 14 can have, on the front side 15, a depression 18 arranged coaxially with the passage 21. FIG. 2 shows the insert element 14 in such an embodiment. The bolt 19 for attaching the insert element 14, in particular the head of a screw, can be arranged in the depression 18 so as not to stand proud of the contour of the insert element 14.

It is also possible that the passage 21 of the insert element 14 has a convexity 24. FIG. 3 shows the insert element 14 in such an embodiment. The convexity 24 is in particular arranged coaxially with the passage 21. In contrast to the depression 18, the convexity 24 is not arranged on the front side 15 but rather inside the insert element 14. On the front side 15 and on the rear side 16, the passage 21 then has in each case a cross section area which is smaller than the cross section area of the passage 21 inside the convexity 24. That section of the passage 21 which extends from the front side 15 to the convexity 24 then serves for example for inserting a tool for turning the bolt 19 during mounting.

According to the invention, the bolt 19 can be part of the insert element 14 and can be arranged in the passage 21 in such a way that its head protrudes into the convexity 24. The bolt 19 is thus arranged in a form-fitting manner in the passage 21 and cannot be removed from the passage 21 toward either the front side 15 or the rear side 16.

Mounting the insert element 14 on the ring segment body 25 creates a ring segment 13 according to the invention.

Although the invention has been described and illustrated in more detail by way of the preferred exemplary embodiment, the invention is not restricted by the disclosed examples and other variations can be derived herefrom by a person skilled in the art without departing from the scope of protection of the invention.

1.-9. (canceled)

10. A gas turbine comprising:
a turbine having a rotor blade row and a ring that is arranged around the rotor blade row and is made up of multiple ring segments,
wherein the rotor blade row is situated downstream of the other rotor blade rows and
wherein at least one ring segment comprises a ring segment body having a hot gas side which, in the mounted state, is oriented toward a hot gas path, and an insert element for covering the recess of a ring segment body of a turbine of a gas turbine,
wherein the ring segment body has, on the hot gas side, a recess and in the recess there is arranged an insert element,
wherein the insert element has a concave front side and a rear side with a rear side profile and the rear side profile corresponds to a negative shape of a recess profile of the recess, and
wherein in the mounted state of the ring segment body in the turbine, the insert element is adapted to be introduced into the hot gas path and fixed to the ring segment body.

11. The gas turbine as claimed in claim 10,
wherein the insert element has at least one passage running from the front side to the rear side.

12. The gas turbine as claimed in claim 11,
wherein the insert element has, on the front side, at least one depression arranged coaxially with the passage.

13. The gas turbine as claimed in claim 11,
wherein the passage has a convexity.

14. The gas turbine as claimed in claim 13,
wherein in the passage there is arranged a bolt which has a head protruding into the convexity.

15. A mounting method, comprising:
fixing an insert element to a recess of a ring segment body of a turbine of a gas turbine,
wherein the recess is arranged on a hot gas side which, in the mounted state of the ring segment body, is oriented toward a hot gas path of the gas turbine, and
in the mounted state of the ring segment body, introducing the insert element into the hot gas path and fixing to the ring segment body.
